(19) United States
(12) Patent Application Publication
(10) Pub. No.: US 2023/0015006 A1
(43) Pub. Date: Jan. 19, 2023

(54) TRANSLUCENT ENCLOSING STRUCTURE

(71) Applicants: Leonid Oleksandrovych LAZEBNIKOV, Kyiv (UA); Ihor Vasylovych SHCHEDRIN, Kyiv (UA); Inna Davydivna LAZEBNIKOVA, Kyiv (UA)

(72) Inventors: Leonid Oleksandrovych LAZEBNIKOV, Kyiv (UA); Ihor Vasylovych SHCHEDRIN, Kyiv (UA); Inna Davydivna LAZEBNIKOVA, Kyiv (UA)

(21) Appl. No.: 17/756,125

(22) PCT Filed: Mar. 30, 2021
(86) PCT No.: PCT/UA2021/000034

§ 371 Date: May 18, 2022

(30) Foreign Application Priority Data
Apr. 1, 2020 (UA) U 2020 02163
Mar. 11, 2021 (RU) 2021106306

(51) Int. Cl. E06B 3/64; E06B 3/663

(52) U.S. Cl. CPC E06B 3/64; E06B 3/66342; E06B 2003/66395

(57) ABSTRACT

A high-strength translucent structures that can be used in industrial and civil construction serving as facade or window structures, as well as for filling gaps in ceilings or raised floors with translucent elements, in the structures of separate sections of both walls and zenith skylights of buildings in required spatial altitude. The translucent enclosing structure includes glass units wherein the sheets of glass are hermetically connected to each other and fixed relative to each other by an internal rigid strengthening profile and a spacer frame, and the glass units are additionally provided with an external strengthening profile of Π-shaped cross-section in the form of a pultruded profile made of glass-plastic. There has been created a sufficiently strong and, therefore, reliable, durable, and cheap translucent enclosing structure designed for use in industrial and civil buildings.

### CROSS REFERENCE TO RELATED APPLICATION

This application is a national stage entry of PCT/UA2021/000034 filed Mar. 30, 2021, under the International Convention and claiming priority over Ukrainian Patent Application No. u 2020 02163 filed Apr. 1, 2020 and Russian Patent Application No. 2021106306 filed Mar. 11, 2021.

### FIELD OF THE INVENTION

The invention refers to the industry field of building materials, namely, high-strength translucent structures, and it can be used in industrial and civil construction serving as facade or window structures, as well as for filling gaps in ceilings or raised floors with translucent elements, in the structures of separate sections of both walls and zenith skylights of buildings in required spatial altitude.

There is a known translucent panel comprising at least two layers of transparent materials arranged parallel at a distance from each other and a spacer frame configured to form an internal closed space, wherein the side surfaces of the frame are attached to the corresponding inner surfaces of the layers. Each transparent material layer is made either of glass, polycarbonate, or polymer film. The spacer frame is made of a rigid material having low thermal conductivity and glued between the above said layers [UA No. 138533 U, E04 D 3/30, Publ. Nov. 25, 2019].

The drawback of the above object is that to be installed in a window opening, a glass unit requires additional frame structures which can be made of a variety of structural materials, such as wood, aluminum, steel, or composite materials.

There is a known building translucent structure formed of two or more glasses that are hermetically connected to each other. The above structure comprises a rigid strengthening profile which is rigidly glued into the gaps between the glasses at their edges, and also an optional spacer frame which is perforated and rigidly associated with a rigid strengthening profile, while the strengthening profile and the spacer frame being rigidly connected to the glasses. In the above glass unit, the profile is attached to the glasses with a special multi-component highly adhesive glue composition [UA Patent No. 114888 U, C04 B 23/00, C04 B 23/24, E06 B 3/66, Publ. 27 Mar. 2017.]

The disadvantages of this utility model include the impossibility of being used without additional frame systems for providing attachment to bearing structures. In this regard, attention should be focused on the fact that, as a rule, these structures are aluminum profile systems, which reduce the thermal technical characteristics of the enclosing structures because of the high thermal conductivity of aluminum, and they also require significant technological gaps because of significant differences in the linear expansion coefficients of glass and aluminum.

The closest to the claimed invention is the translucent enclosing structure comprising a glass unit, wherein the sheets of glass are hermetically connected to each other and fixed relative to each other by a rigid strengthening profile and a spacer frame, while the rigid strengthening profile is the spacer frame stiffening member made in the form of a pultruded fiberglass profile intended for fixing the translucent structures in the required spatial altitude by fixing components made of structural materials mechanically attached thereto. In this case, the spacer frame stiffening member, which is made in the form of a pultruded fiberglass profile, is connected to the multiple glass unit by an adhesive glue composition [FR 2708030 A1, Publ. 27 Jan. 1995.]

The drawbacks of the above translucent enclosing structure are the followings:

It is a narrowness in the field of glass enclosing structures because the application of this patent is exclusively suitable for filling rectangular openings in the walls of the above patent design, which consists of frames and glass panels. This design does not allow implementation in practice of the so-called “wrap-around” facade glazing when the glass units in the facade glazing are lined up in one row and provided with fastening only on the horizontal sides of the glass units. Similarly, this design is not suitable to be used for solid facade glazing of buildings as a whole, because there are occurred visible sashes of the stiffening members, which must be attached to any bearing sub-structure.

Because of the low-tech manufacturing of the described design of the glass unit due to the small recommended gap (1 mm) between the glass panels and the strengthening frame, and also in connection with the availability of the recommended method of integrating the strengthening profile into the glass unit, it was recommended to install first the frame made of the strengthening profile into the glass unit, and then to lay (inject) the glue composition into the formed gaps. At the same time, it was not clear how the process of full filling of all the gaps between the pultruded strengthening profile and the glass panels could be guaranteed, and, therefore, the glass unit's poor tightness was possible due to the appearance of infiltration defects.

There is uncertainty in calculations for the static strength of such a structure. This uncertainty is associated with the fact that the elasticity modules of the pultruded frame and the adhesive glue composition are described separately. As the calculation of the bearing capacity of such a structure, namely, the one consisting of interconnected parts made of various materials, is possible only with the help of finite element analysis implemented in the form of a software package, then for a thin (1 mm) part (adhesive glue composition) of a large length of (up to 6 m), there would be required the finite elements having the side length of the same order (1-3 mm). Thus, with a width of the adhesive glue composition of 10 mm and its length of 11600 mm (a glass unit measuring 4.2×1.6 m), to solve the problem of the static strength of the glass unit, it needs about 930,000 finite elements containing about 1,153,000 nodes (3,459,000 unknowns in the linear algebraic equations), taking into account the frames and glasses finite elements. Such a huge number of finite elements in the calculation model would result not only in a long period of calculation time (about a day), but also in great needs in both operational and disk memory, and at the same time, accumulation of rounding errors in the task of calculating static strength is likely to lead to unreliable results.

In addition, there are only two glass panels in a glass unit, and the recommended space between glass panels is too large and equals 25 mm. And as it is known, any further increase in the above space over 24 mm reduces the thermal technical characteristics of a glass unit, because when the distance between glass panels is more than 24 mm, inside the glass unit, there appear collective flows, which increase the heat exchange between the glass panels and, as a result, worsen its thermal technical properties.

### SUMMARY OF THE INVENTION

The present invention is based on a technical problem of increasing the bearing capacity of a translucent enclosing structure using a modified high strength glass unit (HSGU), which allows it to be used as a structural entity that takes on wind and/or snow load and also meets the thermal technical, technological, and waterproofing requirements in industrial and civil construction.

The problem is solved by the fact that in a translucent enclosing structure, comprising glass units, wherein the sheets of glass are hermetically connected to each other and fixed relative to each other by an internal rigid strengthening profile and a spacer frame, according to the invention, the glass units are additionally provided with an external strengthening profile configured to have a Π-shaped cross-section in the form of a pultruded glass plastic profile.

To fix the glass units relative to each other, the fixing elements in the form of plates made of metallic or non-metallic structural materials can be mechanically attached to the ends of the glass units.

To fix the glass units relative to each other, the fixing elements in the form of angles made of metallic or non-metallic structural materials can be mechanically attached to the ends of the glass units.

To fix the glass units, the fixing elements in the form of angles made of metallic or non-metallic construction materials can be attached to the external and/or internal strengthening profile.

The internal strengthening profile of the glass unit can be rectangular in shape.

The internal strengthening profile of the glass unit can be a shaped tube.

The internal strengthening profile of the glass unit can be oval in shape.

The internal strengthening profile of the glass unit can be Π-shaped.

The glass unit can have both an internal and an external strengthening profile.

The glass unit can have an internal strengthening profile with a strengthening pultruded strip mechanically attached thereto.

The glass unit can be formed of a single-camera design comprising an integrated internal strengthening profile provided with a strengthening trip.

The glass unit can be formed of a two-camera design comprising an integrated internal strengthening profile provided with a strengthening trip.

The translucent enclosing structure, unlike the prototype, is characterized by the design solutions based on modifications of a high-strength glass unit (HSGU).

Manufacturing the HSGU becomes technologically simple due to the modifications provided in the section of the internal strengthening profile, which allows not to inject glue into the gaps, but to press the profile into the space between sheets of glass, or to press the glass unit into the Π/ [symbol] -shaped external strengthening profile.

The HSGU application domain is expanded without the use of additional frame structures configured to install the HSGU into the openings for zenith skylights, removable or built-in facade glazing, “wrap-around” glazing, glass crossings, etc. due to the use of mechanically attaching the glass units both between each other and also to the edges of the openings using angles and/or plates made of metallic or non-metallic materials. There are no limitations on the angle between the connected HSGUs, the number of HSGU sides, and the geometric surfaces of the HSGUs.

The availability remains in static strength calculations both for an individual glass unit and the structure as a whole as a result of introducing the concept of the reduced module of elasticity for an edge connection (spacer frame, adhesive glue composition, and strengthening profiles), the section area of which is more than an order of magnitude larger than the sectional area of an adhesive glue layer, which fact allows to increase by an order of magnitude the minimum size (15 to 30 mm) of the sides of the finite elements describing the edge connection, and this, in turn, results in a significant decrease in the number of finite elements. For example, to solve the problem of static strength of a 4.2×1.6 m glass unit, there will be required approximately 152,000 finite elements containing about 289,000 nodes (867,000 unknowns in the system of linear algebraic equations). In other words, the required volumes of operative and disk memory are reduced, practically, by an order of magnitude, and accordingly, the accuracy of the calculation increases, which fact leads to the guaranteed reliability of the calculation results.

As opposed to the structures comprising conventional multiple glass units, wherein only the external glasses are subject to static strength calculations, the translucent enclosing structure, which includes the HSGU, takes on the properties of a mechanical system of a profile tubular section. This event accompanies by a corresponding change in a calculation model for determining the bearing capacity of the HSGU. The main criterion for improving the bearing capacity with the use of the invention is the reduced rigidity of the HSGU edge connection in translucent structures calculated based on the physical and mechanical properties of a high-adhesive glue composition, shape, and physical and mechanical properties of the internal and/or external strengthening profile; and here is represented the following range of physical and mechanical characteristics:

a) Reduced modulus of elasticity for an HSGU edge connection is more than 4×107 H/m2;

b) Poisson's ratio of an HSGU edge connection is 0.2 to 0.4.

c) Tensile strength of an HSGU edge connection is more than 1.5×106 H/m2.

The HSGU internal strengthening profile can have a rectangular, oval, round, tubular, or any other shape that will increase the entire structure's strength properties without reducing the HSGU manufacturability.

The external strengthening profile in the translucent enclosing structure can be of Π-shaped configuration that will give the properties of increased strength to the entire structure without compromising the HSGU manufacturability.

The connection of the glass unit with the internal and/or external strengthening profile is carried out by a high-adhesive glue composition, which provides a high strength of the connection and the necessary climatic stability.

The translucent enclosing structure obtained with the use of the HSGU is quite strong, reliable, durable, and relatively cheap, which fact makes it suitable to be effectively applied in industrial and civil facilities.

### BRIEF DESCRIPTION OF THE DRAWINGS

The essence of the proposed invention is explained by schematic drawings, where

FIG. 1 shows a typical section of a single-camera HSGU;

FIG. 2 shows a typical section of a blank for a two-camera HSGU;

FIG. 3 shows a typical section of a single-camera HSGU with a pre-filled adhesive glue composition;

FIG. 4 shows a typical section of a blank for a two-camera HSGU with a pre-filled adhesive glue composition;

FIG. 5 shows a typical section of a single-camera HSGU with an internal strengthening profile in the space between sheets of glass;

FIG. 6 shows a typical section of a blank for a two-camera HSGU with an internal strengthening profile in the space between sheets of glass;

FIG. 7 shows a typical section of a single-camera HSGU with an internal strengthening profile in the space between sheets of glass after removing the excess of the squeezed adhesive glue composition;

FIG. 8 shows a typical section of a blank for a two-camera HSGU with an internal strengthening profile in the space between sheets of glass after removing the excess of the squeezed adhesive glue composition;

FIG. 9 shows a typical design solution for connecting the two-camera high-strength glass units, which are arranged in the same plane, between themselves in the translucent enclosing structure of the “wrap-around” type (horizontal section), or the translucent enclosing structure of a zenith skylight (vertical section), while there is no need in the use of additional frame structures;

FIG. 10 is a typical design solution for joining together the two-camera high-strength glass units, which are located at the angle of 90° relatives to each other, in the translucent enclosing structure of the “wrap-around” type (horizontal section), or the translucent enclosing structure of a zenith skylight (vertical section), while there is no need in the use of additional frame structures, and in this case, the glass units are connected outside the room;

FIG. 11 is a typical design solution for installing the two-camera high-strength glass unit into the preliminary prepared opening with the help of the mounting plates made of structural materials in the translucent enclosing structure of the “window” type (horizontal and vertical sections) while fixing the glass units in the opening is provided from the inside;

FIG. 12 is a typical design solution for installing the two-camera high-strength glass unit into the preliminary prepared opening with the help of the seat angles made of structural materials in the translucent enclosing structure of the “window” type (horizontal and vertical sections) while fixing the glass units in the opening is provided from the inside;

FIG. 13 is a typical design solution for installing the high-strength glass units on the load-bearing metal structure made of steel strips, using the plates of structural materials;

FIG. 14 is a typical design solution for installing an inclined high-strength glass unit on the load-bearing metal structure for a zenith skylight, using the plates of structural materials and applying pultruded brackets;

FIG. 15 is a typical design solution for connecting the high-strength glass units with one another in a “wrap-around” facade glazing or in a zenith skylight, using ribbed stiffeners made of structural materials;

FIG. 16. is a typical design solution for installing the high-strength glass units, which are vertical and arranged one over the other, on the load-bearing metal structure;

FIG. 17 is a typical design solution for installing the high-strength glass units, which are vertically arranged one over the other with no visible elements of adjoining, on the load-bearing metal structure;

FIG. 18 is a typical design solution for flat and angular (90°) connections of high-strength single-camera glass units between themselves in a “wrap-around” facade glazing (the installation from the street);

FIG. 19 is a typical design solution for angular (90°) connection of high-strength two-camera glass units between themselves in a “wrap-around” facade glazing (internal wall corner, the installation from the side of the room);

FIG. 20 is a typical design solution for angular (90°) connection of high-strength two-camera glass units between themselves in a “wrap-around” facade glazing (external wall corner, the installation from the side of the room);

FIG. 21 is a typical design solution for angular (>90°) connection of high-strength two-camera glass units between themselves in a “wrap-around” facade glazing (blunt external wall corner, the installation from the side of the room);

FIG. 22 is a typical design solution for angular (90°) connection of high-strength two-camera glass units between themselves in a “wrap-around” facade glazing (external wall corner, the installation from the side of the room);

FIG. 23 is a typical design solution for angular (<90°) connection of high-strength two-camera glass units between themselves in a “wrap-around” facade glazing (sharp external wall corner, the installation from the side of the room);

FIG. 24 shows the structural scheme of integrating the internal strengthening profile of rectangular shape into the single-camera high-strength glass unit blank;

FIG. 25 shows the structural scheme of integrating the internal strengthening profile, which has a configuration of a shaped tube, into the single-camera high-strength glass unit blank;

FIG. 26 shows the structural scheme of integrating the internal strengthening profile of oval shape into the single-camera high-strength glass unit blank;

FIG. 27 shows the structural scheme of integrating the internal strengthening profile, which has a Π-shaped form, into the single-camera high-strength glass unit blank;

FIG. 28 shows the structural scheme of integrating the external strengthening profile, while having no internal strengthening profile, into the single-camera high-strength glass unit blank;

FIG. 29 shows the structural scheme of integrating the internal strengthening profile of a rectangular shape, which has an external strengthening profile, into the single-camera high-strength glass unit blank;

FIG. 30 shows the structural scheme of integrating the combined strengthening profile into the single-camera high-strength glass unit blank;

FIG. 31 shows the structural scheme of integrating the combined strengthening profile into the two-camera high-strength glass unit blank; and

FIG. 32 shows the structural scheme of integrating the internal strengthening profile of a rectangular shape, which comprises a strengthening pultruded strip, into the two-camera high-strength glass unit blank.

### DETAILED DESCRIPTION OF THE INVENTION

The translucent enclosing structure, according to the claimed invention, is explained with the following drawings where:
1—facade sealant
2—high-strength glass unit
3—foamed polyethylene or izolon packing
4—insulant made of extruded polystyrene foam
5—an angle made of a metallic or non-metallic structural material
6—high-adhesive glue material
7—angle stop made of structural material
8—load-bearing structures (walls, ceilings, columns, etc.)
9—anchoring plate (plank) made of structural material
10—pultruded shweller (external strengthening profile)
11—glass sheet of 4-15 mm thick
12—internal strengthening profile
13—spacer frame made of metallic or non-metallic material
14—primary sealing
15—steel self-drilling screw
16—expansion anchor made of steel or dowel
17—steel bearing plate (strip).
18—steel cap nut
19—steel threaded rod
20—pressing steel plate (strip)
21—load-bearing shaped pultruded pipe
22—construction foam-insulation
23—holding pultruded bracket
24—fixing angle of structural materials
25—ribbed stiffener made of structural materials
26—steel load-bearing bracket
27—steel holding clamp
28—pultruded band
29—combined strengthening profile
30—secondary sealing.

In the high-strength glass unit of the translucent enclosing structure, glass sheets 11 are hermetically connected and fixed relative to each other by internal strengthening profile 12 and spacer frame 13. External strengthening profile 10 in the form of a pultruded profile made of glass-reinforced plastic allows mounting the HSGUs of the translucent structure in the required spatial altitude by mechanically attaching the fixing elements, configured in the form of plates 9 or angles 5 made of structural materials, thereto.

External strengthening profile 10 is located outside the HSGU covering the outer surfaces of the glasses of a glass unit, and in special cases, it can be combined with internal strengthening profile 12, and such an integrated profile is located simultaneously both inside and outside the glasses of the glass unit at its specific configuration.

External strengthening profile 10 in the HSGU, which is used in the translucent enclosing structure, can be made of composite material based on glass-plastic pultruded materials.

The HSGU manufacturability consists in the method of production which comprises 3 (three) main stages:

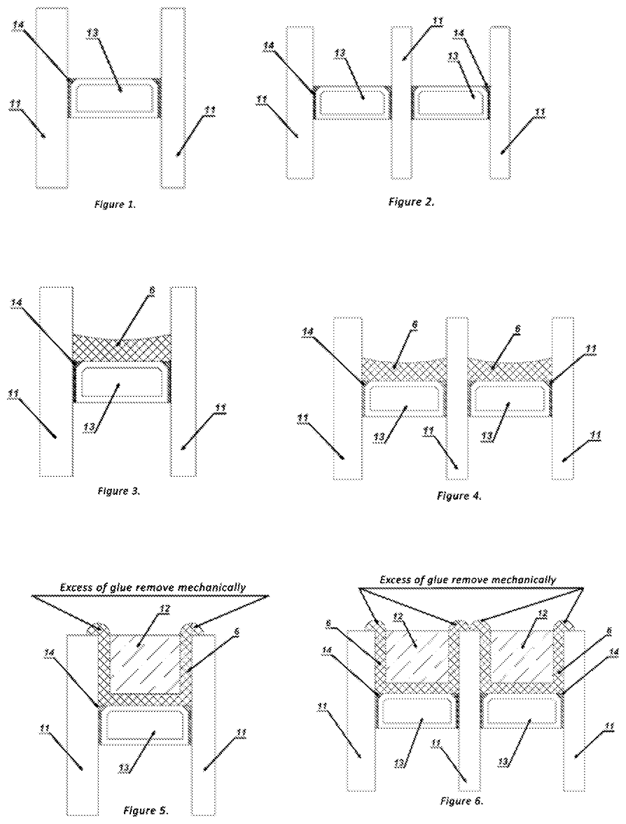

1. N-camera M-angle HSGU blank (in the glass unit, there is only primary sealing) is produced at a glass processing plant using a standard automated line for the production of glass units. FIGS. 1, 2 show a typical section of the blank of single- and two-camera HSGU s.

2. Integrating an internal strengthening profile into the blank of a glass unit is produced in a special shop area at the same glass processing plant by pressing the internal strengthening profile into the space between glass panels, (FIGS. 5, 6), which had been pre-filled with an adhesive glue composition (FIGS. 3, 4), in the HSGU blank located almost vertically. Excess of the squeezed adhesive glue composition is removed and disposed of (FIGS. 7, 8). At the same time, the gaps between the internal strengthening profile and the inner surfaces of the HSGU blank glasses should be within 1.5 to 3 mm.

3. The integration of the external strengthening profile into the HSGU is similar to the integration of the internal strengthening profile into the blank of the glass unit, namely: by pressing the glass unit into the HU-shaped external strengthening profile, which had been pre-filled with the adhesive glue composition on the shop conditions. Excess of the squeezed adhesive glue composition is removed and disposed. At the same time, the gaps between the inner surfaces of the external strengthening profile and the outer surfaces of the HSGU blank glasses should lie within 1.5 to 3 mm.

The invention is explained by the following examples.

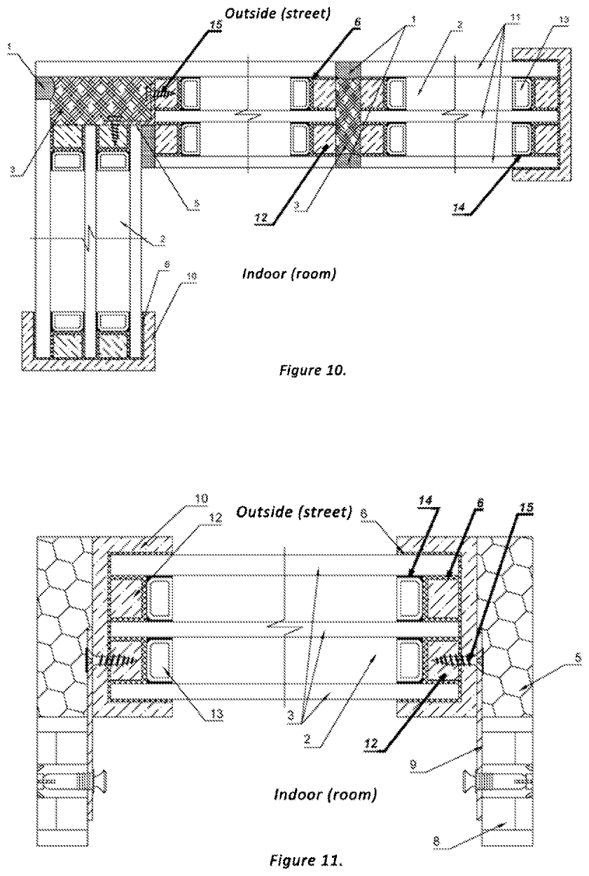

### Example 1 (FIG. 10)

Into the opening prepared for the translucent enclosing structure, there is installed the first glass unit 2 with a smaller projection of the outer glass and with 15 angles 5 (25×25×4 mm) having the length up to 70 mm, with a step of 350 to 500 mm depending on the size of the glass unit and the level of wind loading, while the angles had been mechanically pre-fixed in the area of the joint.

After installing and fixing the first glass unit 2, the second glass unit 2 is installed in such a way that the projection of the outer glass of the second glass unit 2 coincides with the outer plane of the first glass unit 2. Through the technological gap disposed on the street side of the first glass unit 2, the second glass unit 2 is fixed relative to the first glass unit 2 by mechanically fixing 15 angles 5 (25×25×4 mm) to the second glass unit 2, which angles 5 had been pre-fixed to the first glass unit 2.

After mechanically fixing glass units 2, through the technological gap, there is carried out thermal insulation of the joint by filling it with foamed polyethylene or izolon packing 3, followed by sealing the external and internal gaps with facade sealant 1.

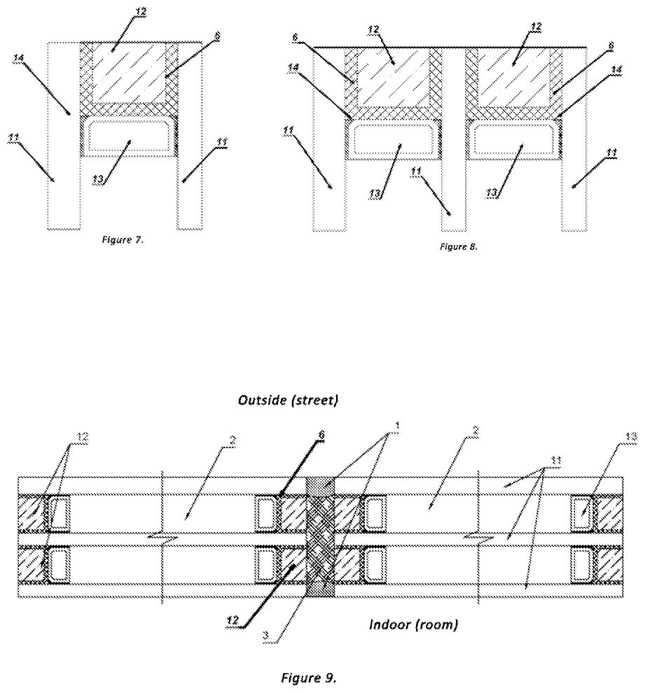

### Example 2 (FIG. 9)

The first glass unit 2 is installed into the opening prepared for the translucent enclosing structure. After installing and fixing the first glass unit 2, there is installed the second glass unit 2 so that the outer planes of the glasses of the first and the second glass unit 2 coincide.

Into a technological gap of 8 to 10 mm wide between the glass units, there is introduced thermal insulation to form the joint of the glass units by filling the gap with foamed polyethylene or izolon packing 3 and subsequently sealing the external and internal gaps using facade sealant 1.

### Example 3 (FIG. 15)

Into the opening prepared for the translucent enclosing structure, there are installed glass units 2 with ribbed stiffeners 25 pre-fixed thereon. Those are made of stainless steel and have a thickness of 1.5 to 5 mm, depending on the size of the glass unit and the level of the wind or snow loading on the entire length of the HSGU sides.

After installing and fixing in the openings of the glass units, ribbed stiffeners 25 are bound together with a threaded stud and nuts 18.

Into the technological gap of 16 to 24 mm wide glass units 2, there is introduced thermal insulation to form the joint of the glass units by filling the gap with foamed polyethylene or izolon packing 3 and subsequently sealing the external and internal gaps using facade sealant 1.

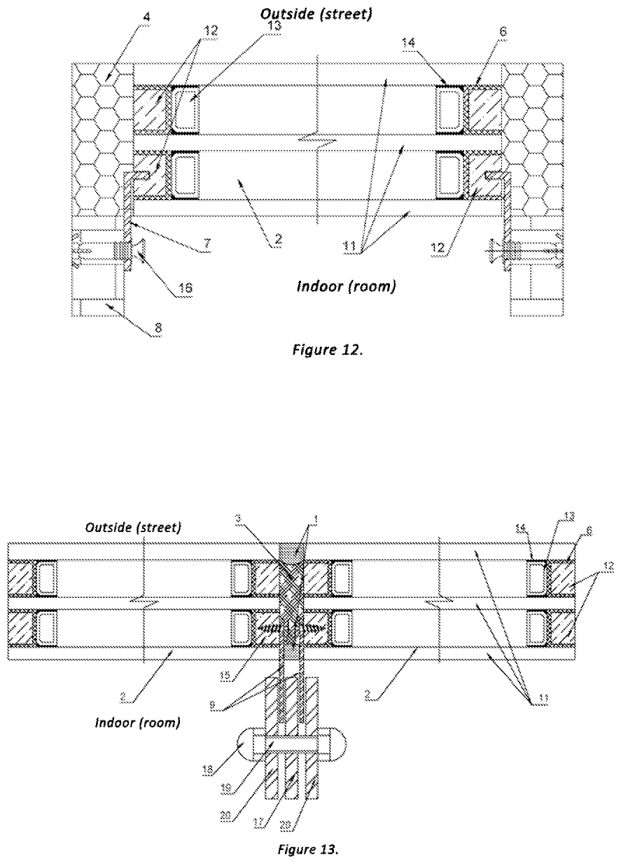

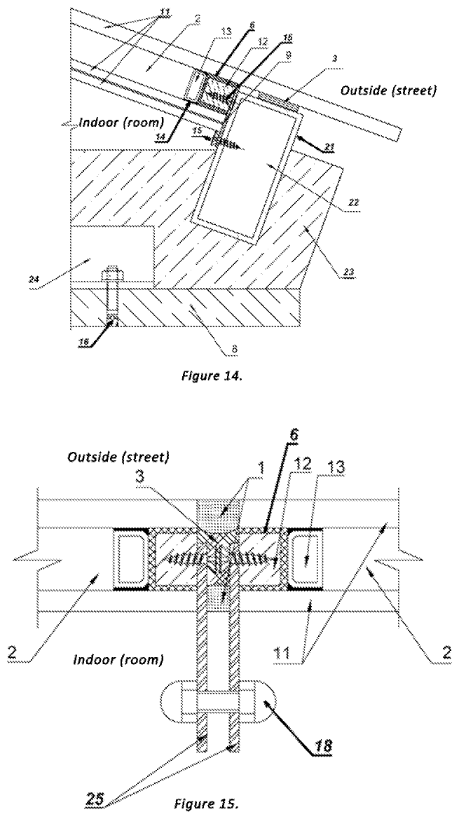

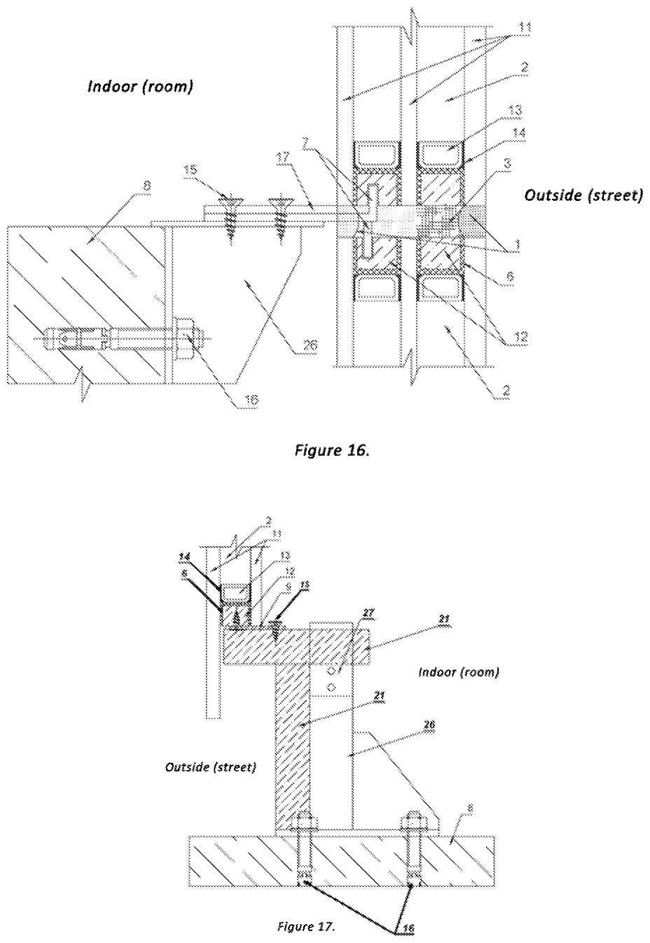

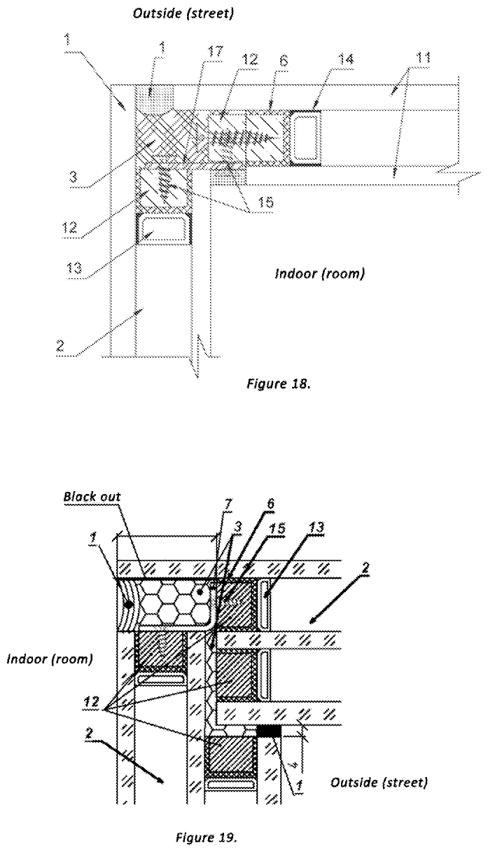

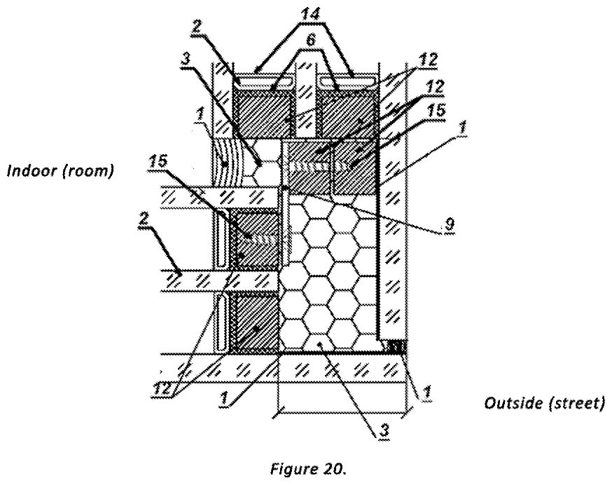

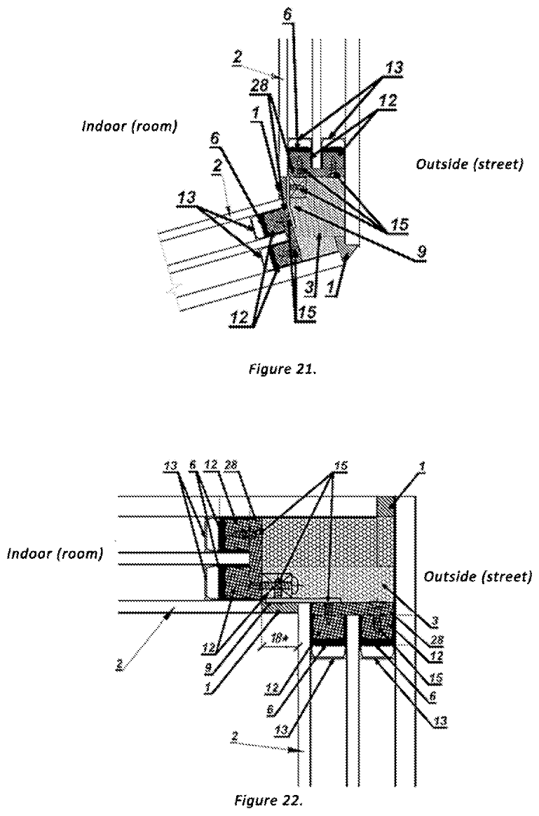

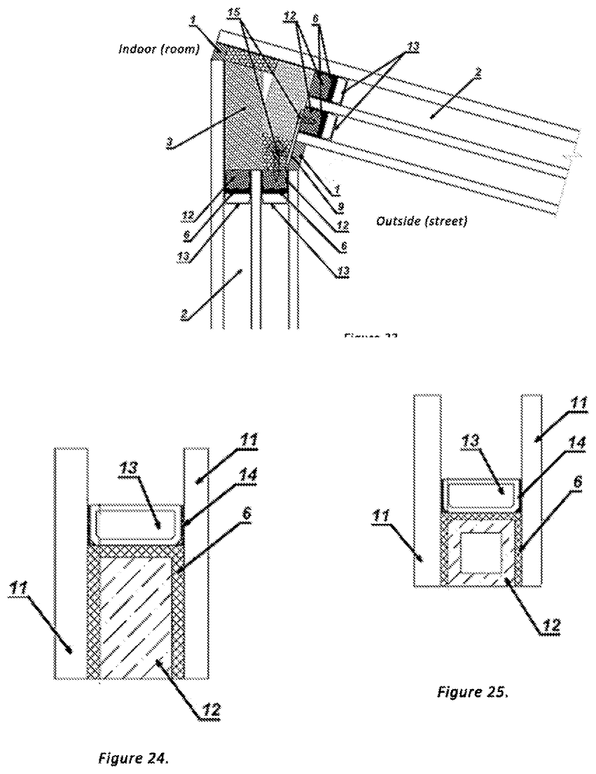

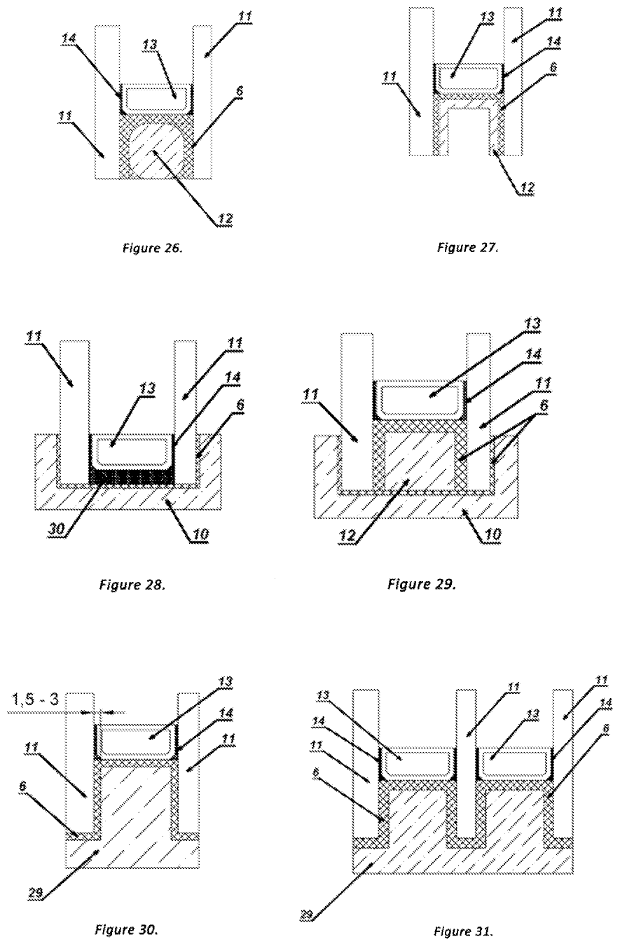

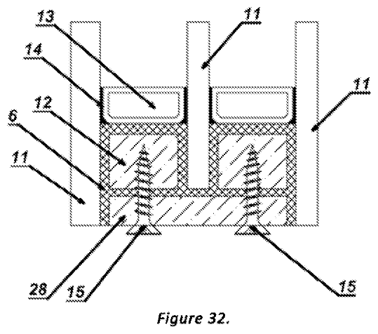

### Example 4 (FIG. 12)

Into the opening prepared for the translucent enclosing structure, there are installed glass units 2 with ┌-shaped bracket-fixers 7 (angle stops) pre-fixed thereon in the special grooves on each of the 2 sides on the top and bottom of a glass unit. Those ┌-shaped bracket-fixers 7 are made of stainless steel; they have a thickness of 2 to 3 mm and the step of fixation of 350 to 500 mm, depending on the size of the glass unit and the level of the wind loading.

In the technological gap between glass unit 2 and load-bearing structure 8, there is introduced thermal insulation by filling the gap with insulant 4 made of extruded polystyrene foam.

### Example 5 (FIG. 11)

Into the opening, there are installed glass units 2, which are pre-glued into external strengthening profile 10 (pultruded Π-shaped profile) with the help of high-adhesive glue sealant 6, and anchoring plates 9 are pre-fixed on the 4 sides thereof with a step of 350 to 500 mm, depending on the size of the glass unit and the level of wind loading.

Into the technological gap between pultruded profile 10 and load-bearing structure 8, there is introduced thermal insulation by filling the gap with insulant 4 made of extruded polystyrene foam.

1. A translucent enclosing structure comprising:
glass units including glass sheets;
wherein the glass sheets are hermetically connected to each other and fixed relative to each other by an internal rigid strengthening profile and a spacer frame;
wherein the glass units are additionally provided with an external strengthening profile configure to have a Π-shaped cross-section in the form of a pultruded profile made of glass-plastic.

2. The translucent enclosing structure according to claim 1, wherein fixing elements configured in the form of plates made of metallic or non-metallic structural materials are mechanically attached to the ends of the glass units to fix the glass units relative to each other.

3. The translucent enclosing structure according to claim 1, wherein fixing elements configured in the form of angles made of metallic or non-metallic structural materials are mechanically attached to the ends of the glass units to fix the glass units relative to each other.

4. The translucent enclosing structure according to claim 1, wherein fixing elements configured in the form of angles made of metallic or non-metallic structural materials are attached to the external and/or internal strengthening profile to fix the glass units.

5. The translucent enclosing structure according to claim 1, wherein the internal rigid strengthening profile of the glass unit is formed rectangular in shape.

6. The translucent enclosing structure according to claim 1, wherein the internal rigid strengthening profile of the glass unit is made in the form of a shaped tube.

7. The translucent enclosing structure according to claim 1, wherein the internal rigid strengthening profile of the glass unit is formed oval in shape.

8. The translucent enclosing structure according to claim 1, wherein the internal rigid strengthening profile of the glass unit is Π-shaped.

9. The translucent enclosing structure according to claim 1, wherein the glass unit further comprises an external rigid strengthening profile.

10. The translucent enclosing structure according to claim 1, wherein the internal rigid strengthening profile includes a strengthening pultruded strip mechanically attached thereto.

11. The translucent enclosing structure according to claim 1, wherein the glass unit forms a single-camera design integrally comprising the internal rigid strengthening profile provided and a strengthening strip.

12. The translucent enclosing structure according to claim 1, wherein the glass unit forms a two-camera design integrally comprising the internal rigid strengthening profile provided with a strengthening strip.
